(19) United States
(12) Patent Application Publication
(10) Pub. No.: US 2007/0168929 A1
(43) Pub. Date: Jul. 19, 2007

(54) DESIGN PATTERN AND METHOD OF TRANSFORMATION OF AN OBJECT MODEL

(75) Inventors: Philippe LARVET, Forges Les Bains (FR); Alain Pastor, Boulogne Billancourt (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/560,757

(22) Filed: Nov. 16, 2006

(30) Foreign Application Priority Data
Nov. 18, 2005 (EP) 05300943.7

(51) Int. Cl. G06F 9/44

(52) U.S. Cl. 717/104

(57) ABSTRACT

The invention relates to a design pattern (70) adapted to be implemented on a computer in a sequence of elementary transformations of an object model (40).

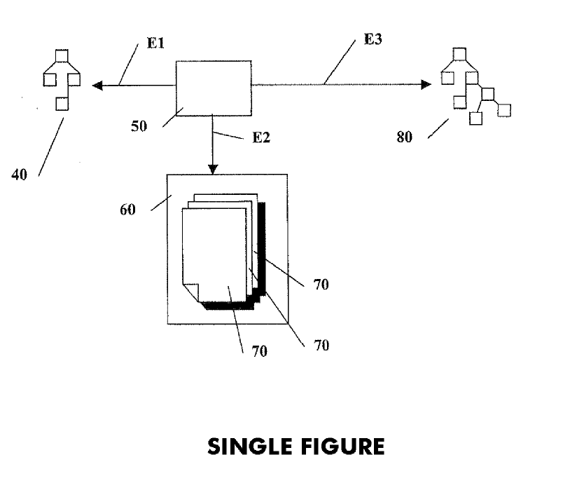

The invention also relates to a computer program product (50), for example comprising a wizard, adapted to interpret this pattern.

It further relates to a method of transformation of an object model, comprising: a step (E2) of accession to said pattern and a step (E3) of execution of the object model's sequence of elementary transformations. Code can then be generated simply, systematically and without errors.

### BACKGROUND OF THE INVENTION

The present invention concerns a design pattern and a method of transformation of an object model.

In the present description, the following terms are employed with the sense indicated, unless otherwise indicated:
“class”: designates the concept of class as commonly manipulated in modeling formalisms and object-oriented programming languages and in particular the aggregation of data and processes (or attributes and methods, respectively) intended to work together in an electronic data processing application. In object-oriented languages, each type of object is defined by its class. A class represents the set of objects sharing the same attributes, operations, methods, relations and semantics.
“diagram”: a graphical representation of a collection of modeling elements, showing for example a graph of arcs (relations) and peaks (other modeling elements). The UML standard proposes the following diagrams: class diagram, object diagram, use case diagram, sequence diagram, collaboration diagram, transition state diagram, activity diagram, component diagram, and deployment diagram.
“code generation”: here designates the automatic or semi-automatic production by a generator of source code for an electronic data processing application. It is effected on the basis of an abstract description of a software application supplied to the generator and serving to control generation. After analyzing this description, the generator constructs the expected output code. This description is generally expressed in a language of higher level than that in which the code will be produced. Thus the generator can be used without having to know the formalism of the programming language used in the generated code.
“Model Driven Architecture” (MDA) designates a set of OMG specifications which relate to a development process utilizing a series of models and their successive transformations. These models integrate a plurality of dimensions of the project and extend from the functional model to the source code model. These models comply with the UML standard. The progression from one model to the other comprises a progressive enrichment of the specifications of the application and uses transformations authorized by the UML metamodel.
“modeling” designates the activity of abstract representation of a statement, a problem or a system, effected with the aim on the one hand of comprehension and of communication of that comprehension and on the other hand of solving the problem or of concrete implementation of the system.
“object-oriented modeling” designates a particular type of modeling in which the modeling elements are classes, objects, attributes, methods, associations, etc. as opposed to “functional modeling” in which the modeling elements are processing functions and streams of data. See also “UML”.
“design pattern” (the term “reusable design pattern” is also used) designates a standardized way of solving a known problem, for example a recurrent architecture or software design problem. A design pattern is an abstract description of a given and recurrent design problem. For example: How to monitor the persistence of objects? How to monitor graphical interfaces? How to control the execution of code? How to apply a state machine? and so on. For example, design patterns have been published in a famous reference work: “Design Patterns, Elements of Reusable Object-Oriented Software”, Erich Gamma & al., Addison-Wesley, Reading, Mass., 1995. Such patterns are distinguished from algorithms, which describe formally how to solve the problem; they are also very often independent of any programming language. The description of such patterns generally conforms to a fixed formalism:
   Name.
   Description of the problem to be solved.
   Description of the solution: the elements of the solution, with their relations.
   Consequences: the consequences of the solution.
“OMG” (Object Management Group), designates an organization one object of which is to define standards in order to guarantee the mutual compatibility of applications programmed using object-oriented languages (cf. http://www.omg.org).
“object”: designates, in object-oriented modeling or programming, a class instance, consisting of a set of data (the inherent data defining the class) and procedures useful for manipulation thereof.
“object-oriented”, refers, for example, to a model, a language, an application or application elements the components whereof are classes and objects. For example, an object-oriented language is a programming language in which the basic components are classes, instances whereof—objects—live dynamically in the electronic data processing program that utilizes them.
“stereotype”, designates a type of modeling element that extends the semantics of the metamodel. Stereotypes must be based on certain types or classes that exist in the metamodel. Stereotypes can extend the semantics, but not the structure, of the pre-existing classes and types. Certain stereotypes are predefined in UML and others may be defined by the user. Stereotypes constitutes one of the three extension mechanisms of UML, the others being “tagged values” and “annotations”.
“UML” (Unified Modeling Language): designates a notation (rather than a language) of modeling by objects, for determining and presenting the components of an object system during its development, as well as generating the documentation thereof, where appropriate. UML is currently the OMG standard. It is the result of the merging of work by Jim Rumbaugh, Grady Booch and Ivar Jacobson, and has evolved in numerous ways. The UML notation, as currently standardized, proposes a graphical representation for different diagrams (see above).

“Object modeling” is known in the art and consists in creating a representation of elements of the real world in terms of classes and objects, independently of any programming language. For example, classes of objects are determined, their inherent data and the functions that use them are isolated. Diverse formalisms exist. UML is one of these formalisms (in fact it is more of a catalog of notations).

Each object-oriented language has a specific way of implementing the class concept. In particular, an object method or a formalism is used to define a problem “at a high level of abstraction” without going into the specifics of a given language. For example, UML offers a tool for easily representing a problem graphically, rendering it more accessible to the different actors involved in its solution.

Typically, an abstract object model is produced first, for example with a view to solving a given problem.

The abstract object model is generally produced in a number of steps. When developing an object-oriented electronic data processing application, a procedure of transformation of models is often used. Thus a plurality of models, which are object models, is manipulated:
first, the “analysis model” (or “profession model” or “problem model”);
then, the “architecture model” (a model of the diverse technological elements that will be used to construct the solution);
crossing the analysis model with the architecture requirements produces the “design model” (or “solution model”); it is initially “general”, then different “design patterns” are applied to it, which turns it into a “detailed design model”;
that model is then ready for producing the final code (what might be called the “implementation model”).

This model is then implemented using an object-oriented language (such as C# or Java). It is therefore desirable for an object formalism to be defined as rigorously as possible, preferably that it be uniquely defined, to minimize ambiguities.

One problem that arises in the context of software project development using Java, C++ or C#, for example in accordance with the MDA specifications, is correctly applying a design pattern (for example, but not exclusively, a pattern taken from the reference work cited above) to a model, for example a UML model, and incidentally generating a corresponding code correctly.

The routine solution to this problem is to apply the pattern manually to the UML model representing the envisaged application design, in order to transform that model into a new detailed UML model from which the code can then be produced.

This solution is not satisfactory, however, because it is manual. It is therefore slow and liable to generate errors. What is more, it may give rise to contradictions in the final model. Additionally, it necessitates applying the patterns one by one.

There is therefore a requirement for a design pattern and a method of transformation of an object model for transforming an object model into a new object model without causing errors or contradictions in the model. Moreover, this design pattern must be designed to enable more efficacious application of a plurality of similar patterns.

### SUMMARY OF THE INVENTION

To this end, the invention proposes a design pattern adapted to be implemented on a computer in a sequence of elementary transformations of an object model, characterized in that each of the elementary transformations is a modification, a suppression or a creation of a modeling element of the object model.

In preferred embodiments, the design pattern according to the invention further comprises one or more of the following features:
the object model conforms to the UML notation;
the pattern can be interpreted by a computer program and the pattern is adapted to trigger the execution of the sequence of transformations by that program; and
the program includes a wizard.

The invention also concerns a computer program product, for example comprising a wizard, adapted to interpret the design pattern according to the invention.

The invention further proposes a method of transformation of an object model, comprising a step of accession to the design pattern according to the invention and a step of execution of the that pattern's sequence of elementary transformations of an initial object model.

In preferred embodiments, the method according to the invention of transformation of an object model comprises one or more of the following features:
the method of transforming an object model comprises, beforehand: a step of accession to the initial object model, the latter comprising a plurality of modeling elements; for each modeling element of the initial object model, a step of searching for an associated stereotype; and, if a stereotype has been found in the search step, a step of searching for the design pattern corresponding to the stereotype that has been found;
the method of transforming an object model comprises beforehand: a step of backing up the initial object model; and
at least some of the steps of the method according to the invention of transforming an object model are effected by a wizard.

The invention further concerns a code generation method comprising the steps of the method according to the invention of transforming an object model and a step of generation of code from the object model transformed in the step of execution of the sequence of transformations.

### BRIEF DESCRIPTION OF THE DRAWINGS

Other characteristics and advantages of the invention will become apparent on reading the following detailed description of embodiments of the invention, given by way of example only and with reference to examples, and from the appended drawing, the single figure whereof shows steps and components of one embodiment of the method according to the invention.

### DETAILED DESCRIPTION OF THE INVENTION

The basic idea of the invention reconceptualizes the design pattern; the design pattern in the sense of the invention is designed so that it can be implemented on a computer in the form of a sequence of elementary transformations of an object model.

This pattern typically includes an identifier corresponding to a given stereotype, so that it can be retrieved.

A given elementary transformation, for example modification, suppression or creation of a given modeling element of the object model, can therefore be easily and systematically effected by an appropriate electronic data processing tool. Furthermore, a given sequence of elementary transformations can be found for a problem solved in the abstract by a design pattern as understood in the conventional sense (i.e. as defined above). Accordingly, implementing a design pattern as a sequence of elementary transformations of an object model causes that object model to evolve towards a detailed model, which thereafter may enable systematic conversion into code (code generation).

More specifically, a design pattern in the sense of the invention may be described by a data structure (for example a computer file) such that, when it is accessed and then interpreted by a program, it triggers the execution of this pattern's the sequence of elementary transformations of the object model. Thus specific procedures are implemented for automatically applying design patterns to a model.

The modeling formalism is typically the UML notation; in this case the modeling elements are the elements conventionally manipulated by UML, i.e. packages, classes, attributes, operations, associations, cardinalities, heritages, etc.

The single figure shows steps and components of one embodiment of the method according to the invention.

The figure represents diagrammatically an initial object model 40 (for example a UML model), a detailed final model 80, a directory (i.e. a “catalog of patterns”) 60 comprising a plurality of design patterns 70 (in the sense of the invention) and a program 50, comprising a wizard (user aid or assistant program), for example. The initial model 40 is a general model, i.e. it is in the form that appears at a stage in the design of the model before the model has a level of detail sufficient to enable generation of code.

The catalog is accessible by the wizard and the design patterns 70 that it contains can be interpreted by the wizard. If necessary, the wizard is interfaced to a modeling tool, such as Rational Rose® from IBM, Objecteering® from Softeam or Rhapsody® from i-Logix. As a result of this, the modeling tool is controlled by the wizard and executes tasks such as an elementary transformation or the conversion of a UML model into code. In this case, the wizard and the modeling tool may be considered as forming the program entity 50.

If necessary, the method according to the invention comprises a step of accession to the initial object model 40 of the application targeted by the developer. This initial model includes a plurality of modeling elements (i.e. model “atoms” to use the standard UML terminology). A model comprises “modeling elements”, for example a package, an attribute or the operation of a class are such elements. The initial model 40 can be analyzed (step E1), i.e. for each “element” of the initial object model there is effected a step of searching for an associated stereotype. If a stereotype is found in the search step, there follows a step of searching for a design pattern 70 corresponding to the stereotype that has been found (step E2).

In practice, the wizard offers the developer the possibility of choosing, in the initial UML model of his application, the modeling element (or the set of elements) to which to apply a given design pattern. To this end, before executing the program, the original model 40 is “marked”, i.e. each element of the model to which a design pattern is to be applied is noted with a specific stereotype the label whereof is the name of the pattern. The program is therefore preferably designed as a user-friendly aid, adapted in particular to the preparatory measurements described above.

The developer then launches the execution of the pattern or patterns 70: to this end, the wizard may access the catalog 60 and select the pattern or patterns 70 to be executed, for example. To this end, the appropriate pattern 70 then includes an identifier corresponding to the stereotype that has been found.

The program can preferably save a back-up copy of the initial model 40 in order to allow for cancellation or the execution of an “undo” command in the event of an error.

The sequences of transformations for a selected pattern 70 are typically produced by way of the modeling tool, in the form of executable scripts interfaced with these tools by the wizard. For example, the wizard is written in the script language offered by the UML environment (for example in VBA for Rational Rose® or in the J language for Objecteering®), and the “design patterns” are read by a module of the wizard that interprets the formal notation of each elementary transformation.

However, the formal notation used for each elementary transformation can remain independent of the UML tool. The patterns themselves are therefore reusable from one UML tool to the other. To this end, an engine of the wizard can be adapted to the environment of each modeling tool. In this case, the program entity 50 (i.e. the wizard plus the modeling tool) is adapted to access and interpret the pattern in order to execute its sequence of elementary transformations.

For example, a pattern 70 may be a set of elementary transformations, each of which is a formal clause independent of any specific modeling tool. In this case, a single generic script may be provided (i.e. the engine of the program 50), which reads the patterns 70, interprets them and executes them.

A sequence of elementary transformations therefore corresponds to a pattern 70. A sequence selected by the wizard is then communicated to a specific “engine” of the program 50 that interprets and executes the transformation sequence (step E3), applied to the object model present in memory in the modeling tool. The execution of this sequence progressively transforms the original model 40 into a more detailed new model 80. Each design pattern 70 (for example: “Singleton”, “Factory”, “Proxy”, “Iterator”, “State”, etc., see the reference work cited) is implemented in the form of a sequence of elementary transformations. Each transformation causes an elementary change of the model 40, for example the addition of an attribute, the creation of a class, the mention of the type of an attribute, the addition of an association, etc. An elementary transformation is therefore an “action quantum”. Each quantum corresponds to an independent action, which is handled by the modeling tool alone, for example. This may be achieved by calling a specific primitive, conforming to the metamodel implemented in the modeling tool (for example: “add attribute”, “rename association”, “create packet”, etc.). A specific sequence of actions solves a specific problem (according to the design pattern). Thus to each pattern 70 there corresponds a procedure that is automatically applicable to the UML model 40 implemented in the modeling tool. A plurality of sequences may additionally be implemented successively and systematically by the same electronic data processing method, given that they have the same logical structure (“action quantum” sequence of the same logical plane), without causing inconsistencies.

The application of elementary transformation sequencers) to the initial model 40 produces a detailed model 80. The detailed model 80 is then used for the automatic generation of the corresponding code, on the basis of an internal proprietary representation of the modeling tool utilized. It should be noted that it is also to this internal proprietary representation that the elementary primitives of transformation of the model may be applied.

The code generated is Java, C++ or C# code, for example. To effect the code generation, for example, the wizard may appropriately instruct the modeling tool, which is provided with a code generator. This is the case with the Rational Rose® modeling tool, for example.

For example, consider the case of a design model 40 to which it is wished to apply the following patterns: the pattern “State” to three classes of the model 40, the model “Singleton” to four classes and the model “Iterator” to two classes. In this example, three State classes of the model are marked with the stereotype “State”, four Singleton classes are marked with the stereotype “Singleton” and two “Iterator” classes are marked with the corresponding stereotype. After marking the model, the program 50 executes the following steps:
copying the original model 40 into the detailed model;
for each class of the original model 40:
   analyzing the class and searching for a stereotype;
   if a stereotype is found:
      searching the catalog 60 for the pattern 70 corresponding to that stereotype;
      starting the execution of that pattern 70 (which creates, modifies or eliminates modeling elements in the detailed model 80);
   end of test “if”;
end of “for each class of the original 40” loop;
// in this step a new detailed design model 80 is constructed;
generation of the code from the detailed design model.

The method described above transforms the initial model 40 into a detailed model 80 systematically, quickly and without errors, and this detailed model is used subsequently to generate code automatically. According to this method, a plurality of design patterns may be applied subsequently to a single execution instruction by the developer, which improves the efficacy of the method. This is possible thanks to the fact that a pattern 70 according to the invention has a given logical structure. Moreover, each pattern 70 having this same logical structure can be implemented after another pattern.

The invention is nevertheless not limited to the variants described hereinabove and is susceptible to numerous other variations that will be readily apparent to the person skilled in the art. For example, it is possible to use the spirit of the mechanism described above:
to create/generate new models from more or less formalized descriptions (from text, for example), which offers an alternative to the UML production mechanism starting from text;
to transform specification models, for example, into analysis object models, using “analysis patterns”, or to construct design object models from analysis models using “architecture patterns”; more generally, application of the invention to any type of object model may be envisaged; it suffices for this to have other types of patterns available, not only design patterns;
to transform models (for example non-object models into object models or from LDS into UML or vice-versa); and
to fabricate language translators (for example translation from COBOL to C or from C to Java, etc.) because a programming language may be described by means of a metamodel and the modes of rewriting one language in another can be translated into the form of design patterns.

It should finally be noted that the invention can also be used to produce design object models from analysis object models by applying “architecture patterns”. To this end, by applying the MDA principles, it is possible to construct design models by “crossing” analysis models with architecture models.

1. Design pattern (70) adapted to be implemented on a computer in a sequence of elementary transformations of an object model, characterized in that each of the elementary transformations is a modification, a suppression or a creation of a modeling element of the object model.

2. The design pattern (70) according to claim 1, wherein the object model conforms to the UML notation.

3. The design pattern (70) according to claim 1, characterized in that:
the pattern can be interpreted by a computer program (50); and
the pattern is adapted to trigger the execution of the sequence of transformations by that program (50).

4. The design pattern (70) according to claim 3, wherein the program (50) includes a wizard.

5. Computer program product (50), for example comprising a wizard, adapted to interpret the design pattern (70) according to claim 1.

6. Method of transformation of an object model, comprising:
a step (E2) of accession to the design pattern (70) according to claim 1; and
a step (E3) of execution of the that pattern's sequence of elementary transformations of an initial object model.

7. The method according to claim 6, comprising, before the steps of claim 6:
a step of accession to the initial object model, the latter comprising a plurality of modeling elements;
for each modeling element of the initial object model, a step (E1) of searching for an associated stereotype; and
if a stereotype has been found in the search step, a step of searching for the design pattern (70) corresponding to the stereotype that has been found.

8. The method according to claim 6, comprising, before the steps of claim 6:
a step of backing up the initial object model.

9. The method according to claim 6, wherein the steps are partly effected by a wizard.

10. Code generation method, comprising:
the steps of the method according to claim 6; and
a step of generation of code from the object model transformed in the step of execution of the sequence of transformations.
